(19) United States
(12) Patent Application Publication
(10) Pub. No.: US 2007/0092149 A1
(43) Pub. Date: Apr. 26, 2007

(54) Method and apparatus of high quality video compression

(76) Inventor: Chih-Ta Star Sung, Glonn (DE)

Correspondence Address: Chih-Ta Star SUNG;RM. 308, BLD. 52, NO. 195, CHUNG HSING RD., SEC. 4, CHU TUNG TOWNSHIP, 310, TW

(21) Appl. No.: 11/256,609

(22) Filed: Oct. 24, 2005

(51) Int. Cl. G06K 9/36

(52) U.S. Cl. 382/239

(57) ABSTRACT

A video compression method compresses the capture video raw data into the 1^{st} compression format and records the image patter complexity of each frame of a predetermined amount of video frames. The information of the image pattern complexity is used to determine the bit rate of each frame for the 2^{nd} time of the video compression. For saving the image buffer size and speeding up the accessing time, a lossless and near lossless video compression algorithm is applied to the 1^{st} video compression algorithm.

### BACKGROUND OF THE INVENTION

1. Field of Invention

The present invention relates to video data compression, and more particularly relates to the video lossless compression and a mechanism of converting the lossless compression video to another lossy video compression format to reduce the data amount while achieving high image quality.

2. Description of Related Art

With top image quality in capturing, processing and display, the semiconductor image sensor including CCD, the Charge Coupled Device has since late year 1970 become adopted in video recording system as the image capturing device as so named “Camcorder” device for recording motion pictures. Due to the consideration of cost, in the past decades, the captured video data within a recording system have been stored into magnetic tapes. Some popular storage media is the 8 mm magnetic tape which can store up to ˜2 hours of VGA (640×480 pixels) resolution with 30 fps, frame per second resolution video. This represents a total of 100 GB (Giga Byte) digitized image data can be stored into a 2 hours tape.

Since the popularity of the technology in digital video compression and VLSI designs, some video recorders are adopting video compression technology like MPEG1, MPEG2, MPEG4 and H.264 as the video formats in video data compression and storage. The compression rate of the popular MPEG video ranges from 50× to 150× which means a data reduction rate of 50× to 150× and implies that a 10 GB HD can store more than 6 hours of video with VGA (640×480 pixels resolution) and more than 20 hours of CIF (352×288 pixels) resolution. The high compression rate of MPEG video also enables the digital recording system to store video into storage device other than magnetic tape including the so named micro “Hard drive (HD)”, or semiconductor memories like “flash EPROM”. HD and flash memory have benefit of small size. Even the cost is still higher, a micro HD and flash memory have become more popular in storing compressed video data with main advantage of small size with fast accessing time.

The advantage of video compression technology like MPEG is the high compression rate ranging from 50× to 150× which reduces the requirement of storage device and time of transmission. The disadvantage of the MPEG video compression technology is the loss of image information since most video compression including MPEG are lossy algorithm which have more or less image data loss to a certain of degree. When recovering from the compressed video sequence, the video scaling mechanism become even complex in achieving good image quality which most likely needs more frames of previous pictures to predict the missing image lost in video compression procedures. Procedures of scaling and playback the compressed video data of lossy algorithm including MPEG is very costly, slow and can not recover back to the quality of the original image. This means the loss of MPEG video causes high cost in de-interlacing during displaying an decompressed MPEG video data.

This invention of the apparatus of video recording and display system provides new video data compression mechanism with top image quality for video recording and display system which provides lossless or near lossless video data reduction or minimizes the rate of data loss and achieves top quality and simplicity in encoding and decoding the video data. This invention also provide the second approach of re-compressing the lossless compressed video into another lossy algorithm with top image quality.

### SUMMARY OF THE INVENTION

The present invention is related to an apparatus of video recording and display system, which plays an important role in video data reduction, specifically in compressing the video data before saving it to the storage device and display with top image quality. The present invention significantly reduces the required storage device density and maintains good quality to the original image quality or minimized loss rate of the raw image data if a lossless or near lossless output/display is selected by the user.

The present invention of the method of video recording and display system applies a lossless video compression mechanism to significantly reduce the requirement of density, bandwidth and power consumption of the first storage device.

The present invention of the apparatus of video recording and display system applies another near lossless video compression mechanism to significantly reduce the density, bandwidth requirement and power consumption of the storage device.

According to another embodiment of the present invention, the first compressed video frames are decompressed and re-compress by a second video compression algorithm.

According to another embodiment of the present invention, the pattern complexity of each frame of the firstly compressed video stream is used to decide the bit rate of the corresponding frame in the second round of the video compression.

According to another embodiment of the present invention, the second round of the video compression is done when the video capturing device is turned off.

According to another embodiment of the present invention, when going through the second video compression procedure from the recorded raw video data stream, the sub-sampled macroblock MADs or MVs within each frame are calculated to determined the quantization parameter or so named “bit rate” of each block.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of block diagram of a raw video data recording and display system.

FIG. 2 illustrates a prior art of block diagram of a video recording and output system with lossy video compression algorithm.

FIG. 3 depicts a block diagram of the present invention of the video recording and display system with lossless or near lossless video compression algorithms.

FIG. 4 depicts the procedure of the present invention of the video compression with the first video compression of lossless compression followed by the second video lossy compression algorithm achieving nice image quality.

FIG. 5 illustrates the block diagram of the design of the present invention of the video compression with of lossless compression and a lossy compression which achieves top image quality.

FIG. 6A illustrates the procedure of the MPEG video data stream coding.

FIG. 6B illustrates the VBV buffer level of the MPEG video data stream coding.

FIG. 7A illustrates the block diagram of the procedure of the present invention of the video compression with top quality by screening and analyzing the video pattern in the first round of video compression.

FIG. 7B illustrates the bit rate of each frame of this invention of high quality video compression.

FIG. 8 illustrates the selecting blocks and pixels for the video pattern analysis.

### DESCRIPTION OF THE PREFERRED EMBODIMENTS

In the past decades since the new venture of the semiconductor CCD image capturing sensor which provides good quality in capturing picture, some still image and motion video related applications have boomed the market. Even the image quality or so named the “Dynamic range” is still far behind CCD sensor, the CMOS image sensors are invading the image sensor market in the past decade. The applications of the semiconductor image sensor in still image include scanner, digital still camera (DSC), in motion video include video conference, Web (or PC) camera, surveillance system, mobile phone, video recorder . . . In the video recording applications, the most popular products include the camcorder, DSC with motion video capturing function and other video recording devices. In the present invention of the video recording and display system, the apparatus applies to but not limited to above products.

FIG. 1 illustrates a prior art video recording system without applying image compression techniques. This kind of prior art video recording system design is popular in the conventional camcorder. The light 10 of an image shooting through a lens 11 are captured by an image sensor 12 which might be either CCD or CMOS image sensor. After a procedure of image processing 13, which might include color compensation, gamma correction . . . the image is save into a storage device 15 which in camcorder might be an 8 mm tape, hard disk or other media like semiconductor memory. The captured and stored video can be sent out through output buffer 14 and display interface 16 and exported to output device including TV, DVD player, display panel 18 or to other media for possible manipulation. This kind of video recording system is classified into “lossless” image/video recording.

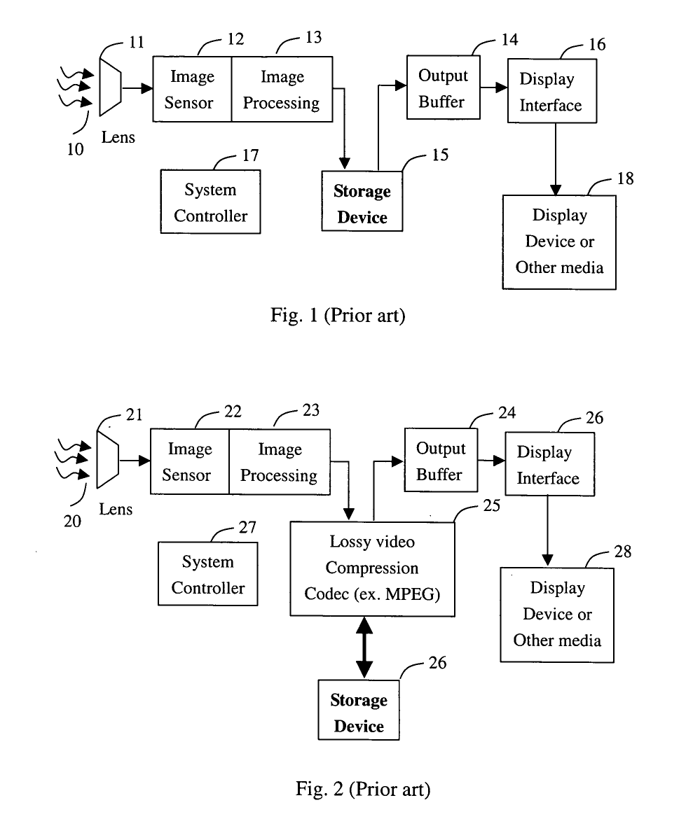

Another alternative of video recording is a “lossy” mechanism as shown in FIG. 2 which has become more popular after MPEG is adopted as a video compression standard and is supported by most computers, DVD players and some portable devices. The main difference between FIG. 1 prior art and the FIG. 2 prior art is that the captured and processed image goes through a procedure of video compression 25. Light 20 of an image shooting through a lens 21 are captured by an image sensor 22 which might be either CCD or CMOS image sensor. After a procedure of image processing 23, the motion video goes through a mechanism of video compression 25 before saving into a storage device 25 which in camcorder might be an 8 mm tape, hard disk or other media like semiconductor memory. During outputting, the saved video stream is decompressed 25 before sending to the output buffer 24 and the display interface unit 26. Some display devices have capability of decompressing the video stream, and the video stream can be directly sent to that device for decompressing and display 28. Some media like PC might have decompression feature and the output video stream is sent to that media 28.

The benefit of FIG. 2 prior art of applying a lossy video compression mechanism is that it reduces the amount of video data significantly. Taking MPEG2 as an example, it is common that MPEG2 reaches the compression rate of 100 times, which means a video stream of 2 hours VGA (640×480 pixels per picture) resolution of 30 frame per second video (65 Giga Byte) data can be reduced to be 500-600 Mega Byte (500 MB-600 MB). With 100× compression rate, even the MPEG2 video looks not very good quality, it saves data amount significantly and makes a storage device record 100× longer time of compressed video stream compared to the prior art of not compression mechanism in FIG. 1. The lossy vide compression like MPEG2 with acceptable good image quality has an average of mean absolute error (MAE) of 2, ˜1% error for most blocks of pixels, which stands for 37 dB compared to the original video data.

This invention of the video recording and display system applies compression technology to reduce the amount of video data with top image quality. The main differentiation of this invention to the prior art in FIG. 2 is that the present invention applies video compression technique which can reach lossless or near lossless video quality or significantly reduces the mean absolute error (MAE) rate down to well below 0.1% or instead of 1% in MPEG video compression. When determining lossless image quality of the video compression, the present invention generates the video data with all pixels having no error compared to the original video stream. When selecting a “near lossless” mechanism, most pixels in the video stream will still have no error compared to the original video stream. Only a few pixels for example said less than 30% of pixels have a little error compared to the original video stream.

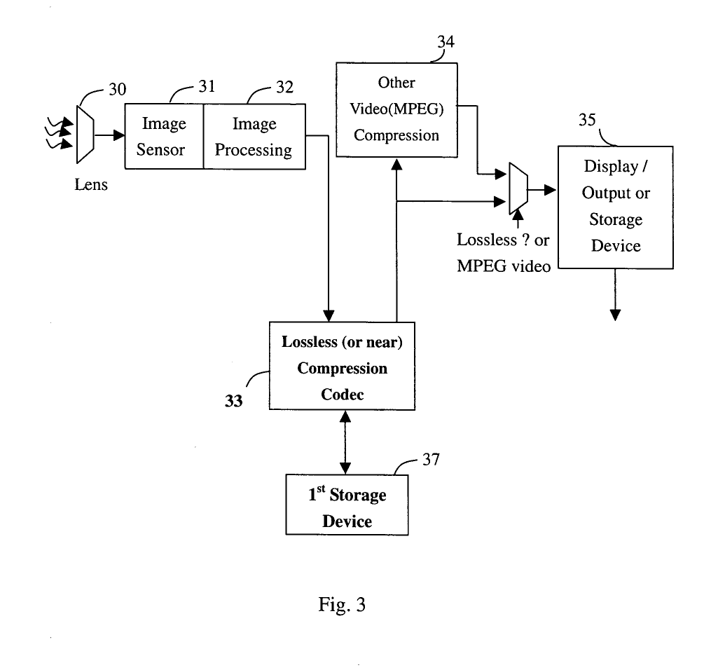

FIG. 3 illustrates the block diagram of the present invention of the video recording and display system. Compared to the two above prior art video recording, the present invention applies “lossless” or “Near lossless” compression mechanism to significantly reduce the amount of video data which can obtain top image quality.

The image continuously shooting through a lens 30 are captured by an image sensor 31 which might be made by either a CCD or a CMOS image sensor array. After a procedure of image processing 32, which might include color compensation, gamma correction . . . the image data of the motion video goes through a procedure of “lossless” or “Near lossless” compression 33 before saving into the 1^{st} storage device 37 which might be a magnetic tape, hard disk or semiconductor memory like DRAM. The captured, compressed and stored video can be exported to the output device 35 including but not limited to PC or to other storage device for possible manipulation. Software of decoder can be installed to decompressed the exported compressed video data. This kind of video recording with lossless or near lossless compression algorithm has high amount of pixels having no error compared to the original pixels of the video data stream. If lossless compression is decided, all pixels of the compressed video stream can be reconstructed to be exactly the same like the original video stream without any error of all pixels. If “near lossless” is the selected target of the video compression, the compression rate can be higher than the lossless compression with a little sacrifice of image quality.

Since MPEG is a popular international video compression standard with high compression rate, another optional design of this invention inserts video (ex. MPEG) encoder 34 to compress the recovered lossless or near lossless compressed video data into MPEG compatible video stream.

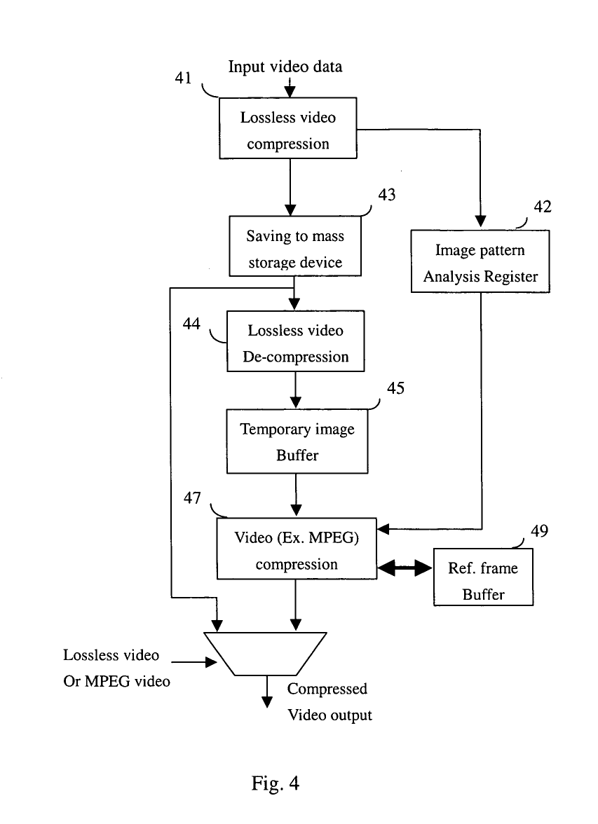

FIG. 4 depicts the detailed procedure of this invention of the lossless (or near lossless) video compression and the lossy video compression with recovered video data from the lossless compressed data stream. The digitized raw video frames goes through a lossless compression procedure 41. In the mean time, the bit number of the lossless compression of the output of the compressed video or the pixel data truncation number of the near lossless video compression algorithm can be used as a reference of image pattern analysis which judging the image quality and complexity 42 of each video frame. The compressed video data stream is then saved into a mass storage device 43 which might be a magnetic tape, hard disc or a semiconductor memory like DRAM or Flash memory. If an MPEG video format is decided, the firstly compressed video data with lossless compression algorithm is to be decompressed 44 and some of the recovered frames should be stored in a temporary buffer 45 and re-compressed by the MPEG video compression algorithm. The image quality and image patter complexity data coming from the first lossless compression algorithm is used to decide the bit number of each frame of in the MPEG video 47 compression. Another temporary image buffer 49 storing two reference frames, the I-frame or P-frame of pixels.

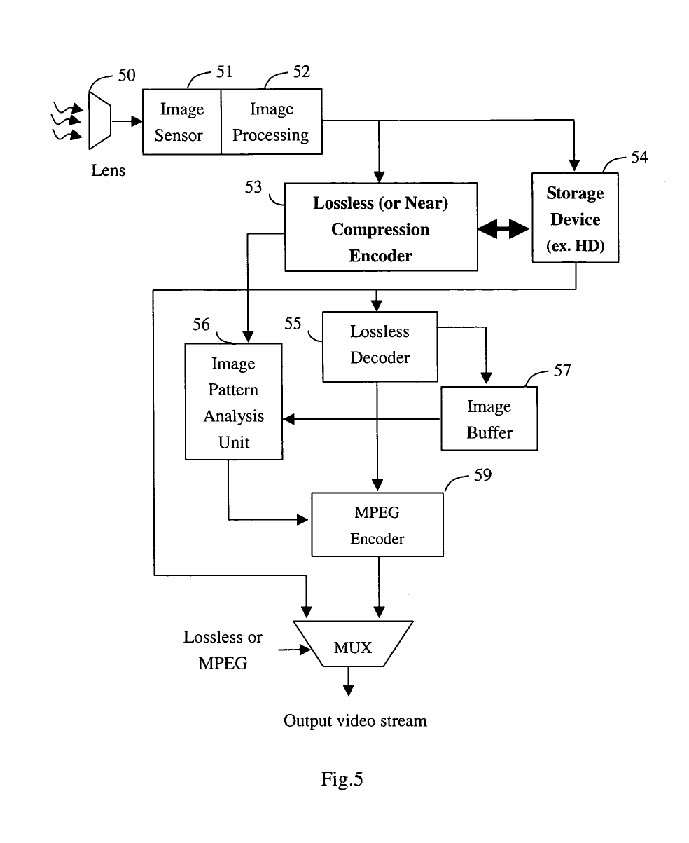

FIG. 5 shows the block diagram detailing the implementation of the present invention. The light goes through the lens 50 and been captured by an image sensor 51 which can be a CCD or a CMOS sensor, then being manipulated by color procession 52 unit. The image then is compressed by a lossless compression encoder 53. The lossless video compression codes the image information by an intra-frame and inter-frame coding. During intra-frame coding, the compression engine reduces the image data by coding the redundancy of itself, while, the inter-frame coding reduces the redundant information between adjacent frames. In the case of inter-frame coding, a “Best Matching Algorithm” (so called “BMA”) is adopted to identify the best matching block of previous frame. The BMA method calculates the values of the SAD, Sum of Absolute Difference of each position within a predetermined searching range, the block of the position with the lowest SAD is identified as the best matching block.

The mean absolute difference, MAD or sum of absolute difference, SAD as shown below, is calculated for each position of a block within the predetermined searching range, for example, a +/−16 pixels of

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

the X-axis and Y-axis. In above MAD and SAD equations, the Vn and Vm stand for the 16×16 pixel array, i and j stand for the 16 pixels of the X-axis and Y-axis separately, while the dx and dy are the change of position of the block.

After the best matching block is identified, the differences of the target block and the best matching block of previous frame is coded by variable length coding (or so named “VLC” coding). Sacrificing a little image quality by truncating differential values between the target block and the best matching block pixels helps achieving higher compression rate which can be claimed as “near lossless algorithm”. A lossless video compression can reach around 8×compression rate, meanwhile, the near lossless compression can reach 20× compression with PSNR (Peak Signal Noise Ratio) more than 60 dB image quality. If the video with lossless or near lossless compression algorithm is selected, the compressed video data stream is saved into a storage device 54 which can be a magnetic tape, hard disc or semiconductor memory. If other video compression algorithm with lossy algorithm like MPEG is selected, then, the 1^{st} compressed video data can be retrieved from the storage device and decoded by a decoder 55 before sending to the MPEG encoder 59 for the 2^{nd} video compression. During the 1^{st} video compression of lossless or near lossless algorithm, some information like the SAD, image quality (in dB for PSNR) and bit rate are fed into an image pattern complexity analysis unit 56 as reference for the 2^{nd} video compression.

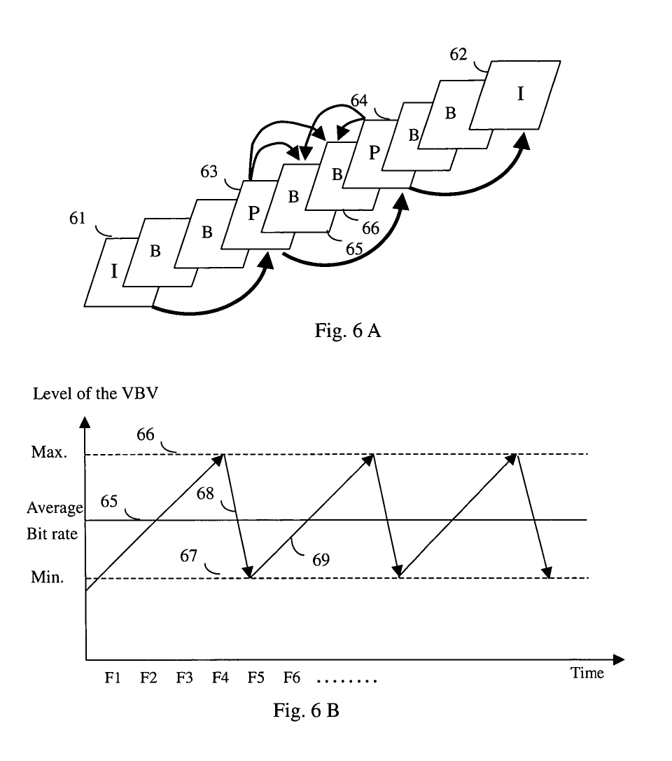

FIG. 6A shows 3 types of coding the MPEG video compression, which is prevailingly popular motion video compression standard adopted by video compression IC, software and system suppliers. Most MPEG video streams have more than 70% of pixels encompassed more or less data loss compared to the original raw video data that is caused by the step of “quantization” procedure. The I-frame 61, 62 coding uses only the information within a frame to code the information, the P-frame 63, 64 use previous I-frame or P-frame as a reference frame to code the difference between the current frame. The B-frame 65, 66 coding uses previous frame and the next frame to code the difference between the target frame. During MPEG video compression, a VBV, or so named “Virtual Buffer Verifier” is adopted to measure and tracking the level of the “virtual” image data buffer to decide when and how to make the data amount of the image buffer within a predetermined levels. For instance, the 30 frame per second video with 720×480 resolution, if 1 MB (million Byte) per second is the determined bit rate, the average bit rate for each frame will be 33.33 KB which is also the targeted bit rate 65 for the VBV control. When the level of the VBV rises up to a threshold (maximum) 66, the MPEG encoding should take larger quantization step and filters out more information which quickly reduces data rate to let the VBV level drop quickly 68 down to another threshold level 67 before the quantization parameter is set back to allow higher bit rate for each frame of video data and the level VBV will increase 69 again. Therefore, the MPEG video compression procedure has the VBV buffer level zig-zag between two predetermined levels over time.

One of the drawbacks of the prior art MPEG related video compression algorithms is that the level control of the VBV is done by measuring the “past” video frames. Which also means the bit rate distribution of each frame is decided by the VBV buffer level of the accumulated bit rate of the past frames. Taking one picture with complex pattern as an instance, should the past continuous pictures are complex and making VBV level high, the target frame should also be compressed by using larger quantization step to avoid overflow of the BVB no matter what image pattern in front of it.

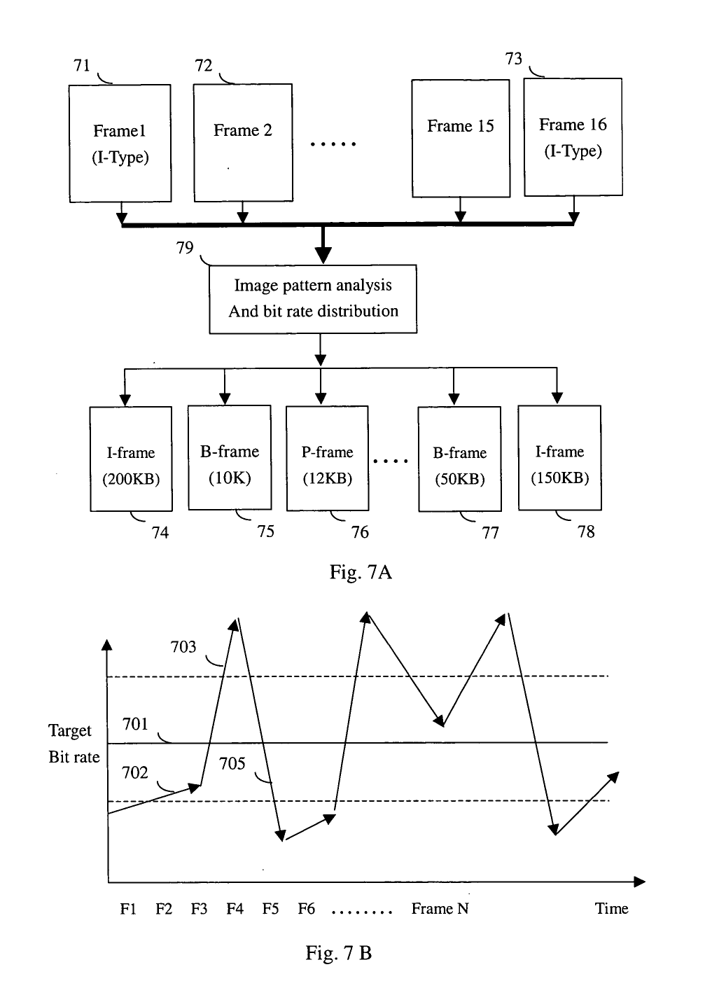

One of the present invention of video compression with lossy video compression algorithm (ex. MPEG), it quickly reviews and analyzes the complexity 79 of the image patterns of a predetermined amount of frames as shown in FIG. 7A. The continuous input of image 71, 72, 73 are compressed by a lossless (or near lossless) video compression algorithm to reduce the requirement of memory density and bandwidth. In the mean time, the image pattern information, the degree of complexity of each frame is calculated and saved in a temporary register and used to decide the bit rate distribution of each frame in the video compression with the 2^{nd} algorithm like MPEG compression. When the complexity of each frame is calculated, the bit rate of each frame in MPEG video compression can be determined accordingly. And the bit rate can range widely according to the pattern complexity of the raw image. For instance, the commonly used solution in encoding an MPEG video stream with 1 MB per second might have bit stream of 33 KB (+/−20 KB range) per frame, in this invention, the bit rate of each frame can for instance, range from 5 KB for a frame with simple pattern 75 to 200 KB for an I-frame 74 or 50 KB for a B-frame with complex pattern 77. Instead of using only VBV level as the factor of determining the bit rate or quantization step, this invention analyzes the image information of not only the past images but also the future images which helps achieving high image quality. A pipelining architecture is applied in practical implementation of this invention of the lossy video compression like MPE video. After buffering about 5 to 30 frames in a storage device, the MPEG compression unit starts MPEG compression. Before the MPEG compression of all the buffered frames is done, the next 5 to 30 frames are buffered and analyzed and read for the next round of MPEG video compression. Since the required time of the 1^{st} lossless compression and decompression plus analyzing the complexity is less than the time required for MPEG video compression, the pipelining architecture of buffering 5-30 frames and analyzing the complexity and the MPEG compression can be run synchronously. FIG. 7B shows the bit rate of each frame. The beginning of a video stream might have simple image pattern which require low bit rate 702 for each frame. When new object shows up to the image in later frame, the complexity becomes higher and bit rate shoots up 703 abruptly. The following frames will require much less bit rate than the one having new object and the bit rate drops sharply 705.

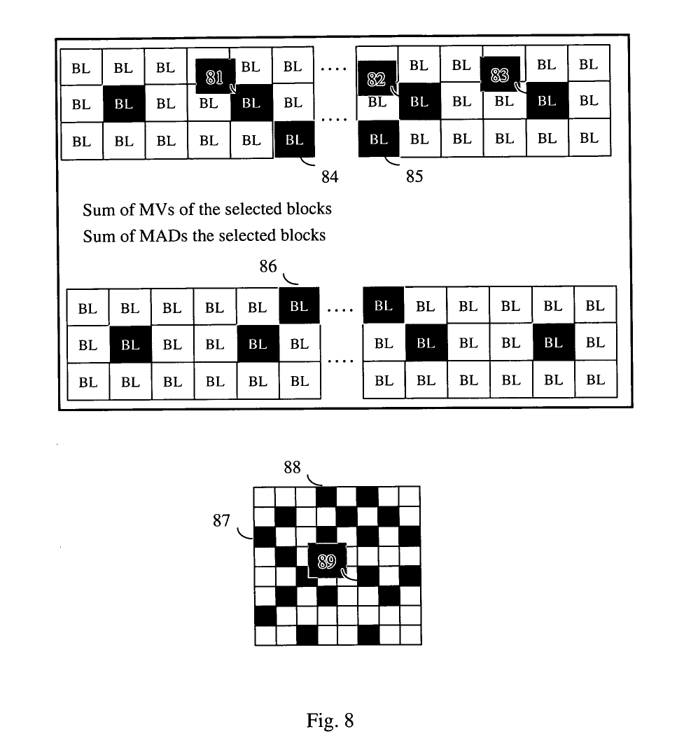

In analyzing the complexity of the image pattern, some factors can be used as references including the SAD (or MAD), Motion Vector (MV, or displacement), PSNR (image quality) and bit rate (compression rate). Theoretically, the higher value of the SAD or the MV, the more complex the image will be and the more bit should be allocated to represent the image information to keep high image quality. As shown in FIG. 8. for saving the time of calculation, this invention calculates SAD of not all blocks pixel information within an image. In principle, the more blocks are included the higher the accuracy can be reached. In average, one of every two to ten blocks 81, 82, 84, 85, 86 (in filled block boxes) of pixels are included in calculating the SADs or MVs of a frame. For further saving the time of computing, only a certain pixels 86, 87, 88 of a selected block are included in calculating the SAD/MAD or MV.

When applying this invention of the video compression, the 1^{st} compressed video stream stored in the mass storage device can be retrieved and re-compress by using the 2^{nd} video compression algorithm when the recording system is turned off.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A digital video compression method for manipulating at least one captured raw image, comprising:
compressing the captured digital video data of at least two raw images with the first video compression algorithm which has the majority of the decompressed pixels having no difference compared to the original raw image data;
saving the compressed image into the first storage device;
extracting and recovering a predetermined amount of the compressed video frames and storing them into the second storage device;
calculating the complexity of the image patterns of the video frames recovered and stored in the second storage device; and
re-compressing the reconstructed video frames by a second video compression algorithm according to the complexity of each recovered image from the first compressed video stream.

2. The method of claim 1, wherein the first compressed video data is saved into the first storage device which has higher density than the second storage device for saving the compressed video stream by the second video compression algorithm.

3. The method of claim 1, wherein the bit number of each frame of the compressed video stream of the first compression algorithm is rounded to be another number to be saved in a temporary storage device and used as a reference to determine the bit number of the corresponding frame for the video compression with the second video compression algorithm.

4. The method of claim 1, wherein the accumulated SAD of at least two selected block of the best matching blocks pixels in the 1^{st} video compression with lossless or near lossless algorithm is used to determined the bit rate for the 2^{nd} video compression algorithm.

5. The method of claim 1, wherein the accumulated absolute values of the motion vector displacement of at least two selected block of the best matching blocks pixels in the 1^{st} video compression with lossless or near lossless algorithm is used to determined the bit rate for the 2^{nd} video compression algorithm.

6. The method of claim 1, wherein the number of image frames between two I-frames is adaptively determined by calculating the accumulated bit number of the image frames of the compressed video stream by the first video compression algorithm.

7. The method of claim 1, wherein the second image storage buffer used to store the recovered image data from the first video compression algorithm can save at least one frame of image pixels.

8. The method of claim 1, wherein the first video compression algorithm encodes the video stream by the combination of Intra-frame and Inter-frame coding methods for each of the macro-block within a frame of pixels.

9. A method of compressing the video frames with high image quality, comprising:
capturing the video stream of continuous image frames;
analyzing the image pattern complexity of each frame of a predetermined amount of the continuous video sequence frames;
determining the bit number to be assigned to each frame of the continuous video sequence an image according to the complexity of the image pattern of each frame; and
encoding the video stream according to the assigned bit number of each image of each block of pixels.

10. The method of claim 9, wherein the best matching algorithm takes the block of a location with a minimum value of pixel SAD within a predetermined searching area as the best matching block.

11. The method of claim 9, wherein a temporary storage device is used to save the accumulated SAD of at least two blocks of pixels and be used to determine the bit rate of each frame of a predetermined amount of the continuous video frames.

12. The method of claim 9, wherein the video compression procedure is taking place during the analyzing the image pattern complexity of a predetermined amount of the continuous video frames.

13. The method of claim 9, wherein during the recording system is turned off, the 1^{st} compressed video stream is recovered and is re-compressed by the 2^{nd} video compression algorithm.

14. An apparatus of compressing the video stream with high image quality, comprising
a compression engine to reduce the video data rate of the predetermined amount of video frames by using the 1^{st} video compression algorithm;
a storage device to save at least two frames of the 1^{st} compressed video stream for future usage in the 2^{nd} time of further compressing the video stream;
an image analyzing unit which analyzing the complexity of at least two selected blocks of each frame of a predetermined amount of vide frames; and
a second video compression engine which reduces the data rate of the video stream by referring to the previously saved information of the pattern complexity of each frame of a predetermined amount of video frames;

15. The apparatus of claim 14, wherein in compressing the video stream by using the 1^{st} compression algorithm, the information of the pattern complexity of each frame of a predetermined amount of video frames is calculated and saved in to a temporary storage device.

16. The apparatus of claim 14, wherein the image analyzing unit is an engine which calculates the accumulated SADs or MAD of at least two selected block of pixels of each frame of a predetermined amount of video frames.

17. The apparatus of claim 14, wherein the image analyzing unit is an engine which calculates the accumulated displacement of the motion vectors of at least two selected block of pixels of each frame of a predetermined amount of video frames.

18. The apparatus of claim 14, wherein the image analyzing unit is an engine which calculates the accumulated SADs or MAD of at least two selected block of pixels of each frame of a predetermined amount of video frames.

19. The apparatus of claim 14, wherein the majority pixels of the recovered image from the 1^{st} video compression algorithm having no difference compared to the original image.

20. The apparatus of claim 14, wherein the predetermined amount of the video frames which are temporarily saved for further re-compressing by another video compression algorithm has at least two frames of image.
